(19) United States
(12) Patent Application Publication
(10) Pub. No.: US 2011/0089826 A1
(43) Pub. Date: Apr. 21, 2011

(54) HALOGEN INCANDESCENT LAMP

(75) Inventors: Janbernd Hentschel, Eichstaett (DE); Ute Liepold, Muenchen (DE); Khanh Pham Gia, Neubiberg (DE); Steffen Walter, Oberpframmern (DE); Raquel de la Pena Alonso, Muenchen (DE)

(73) Assignee: OSRAM GESELLSCHAFT MIT BESCHRAENKTER HAFTUNG, Muenchen (DE)

(21) Appl. No.: 12/908,960

(22) Filed: Oct. 21, 2010

(30) Foreign Application Priority Data
Oct. 21, 2009 (DE) 10 2009 050 202.5

(51) Int. Cl. H01K 1/50

(52) U.S. Cl. 313/579

(57) ABSTRACT

A halogen incandescent lamp may include a bulb, in which a light-emitting element and a fill with a halogen-containing additive is accommodated, the halogen containing F, wherein a fluorine-resistant layer which is passive at suitable temperatures is accommodated in the interior of the bulb and completely covers the inner wall.

### CROSS-REFERENCE TO RELATED APPLICATION

This application claims priority to German Patent Application Serial No. 10 2009 050 202.5, which was filed Oct. 21, 2009, and is incorporated herein by reference in its entirety.

### TECHNICAL FIELD

Various embodiments are based on a halogen incandescent lamp. Such halogen incandescent lamps are intended e.g. for operation at high voltages (HV) of typically from 100 to 250 V. However, operation at low voltages (LV) is also possible.

### BACKGROUND

U.S. Pat. No.3,022,438 has disclosed a halogen incandescent lamp which is equipped with layers consisting of CaF2. The light-emitting element is manufactured from TaC. The fill may contain halides such as Br, Cl or F.

### SUMMARY

In various embodiments, a halogen incandescent lamp may include a bulb, in which a light-emitting element and a fill with a halogen-containing additive is accommodated, the halogen containing F, wherein a fluorine-resistant layer which is passive at suitable temperatures is accommodated in the interior of the bulb and completely covers the inner wall.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a side view of a halogen incandescent lamp; and

FIG. 2 shows an exemplary embodiment of a double-ended lamp.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Varius embodiments enable a long life for halogen incandescent lamps which contain fluorine as a fill constituent.

For a regeneration process at the light-emitting element consisting of tungsten in a halogen incandescent lamp, the fill should contain fluorine compounds such as WF6. In addition, other halides may be contained. However, the quartz glass of the bulb is corroded by the fluoride. A protective layer is therefore required which includes a material which is subject to the following demands:

chemically inert with respect to gaseous fluorides, even at temperatures of up to 500° C.;

thermally stable up to at least 500° C.;

optically transparent;

good adhesion to the glass wall;

sufficiently resistant in order to provide protection of the glass wall against attack by fluorides.

Conventional coatings for this purpose contain Al₂O₃ or CaF₂. It has been shown that the desired stabilization cannot be achieved thereby. Until now, no alternatives have been known.

According to various embodiments, the inner side of the bulb is now coated completely with a layer of a transparent, thermally stable material which is chemically inert to attack by fluoride or a mixture of a plurality of suitable materials. The layer is applied in such a way that it adheres closely to the glass wall and is sufficiently resistant to protect the glass effectively from attack by fluoride.

Suitable materials are, alone or in combination with one another, for example:

fluoridic compounds such as MgF₂, BaF₂, AlF₃, LaF₃, YF₃, CeF₃, TbF₃;

rare earth fluoride glasses of the type SEF3 (in this case SE stands for rare earth metal);

ZrF₄ and fluorine zirconates;

Na₃AlF₆, Na₅Al₃F₁₄, Ca₅(PO₄)₃F; Al₂F₂SiO₄ and fluoroalkyl silanes such as —Si—(CₓH_{(2x+1)-y}F_{y})_{z} and fluorinated polyimides. In this case, x, y and z are in a range of from 1 to 5.

With at least one or else a mixture and layering of a plurality of these materials, the inner side of the bulb is coated completely and in resistant fashion, such that stabilization with respect to attack by fluoride is ensured. Thus, a basic precondition for a fluoride cyclic process for the regeneration of the light-emitting element from W or TaC is provided.

The layer is applied by way of example by coating methods such as a wet-chemical sol gel process with subsequent fluorination or by evaporation methods such as vacuum deposition, electron beam deposition, laser beam deposition or else plasma-assisted or laser-assisted electron beam deposition. In this case, the evaporation methods are more suitable for the relatively simple, inorganic fluoridic compounds, while even the more complex, e.g. organic materials can be applied as a layer using the sol gel route.

By means of sol gel methods, first gel layers and then, after corresponding thermal treatment, oxygen-containing layers are produced which are fluorinated in a subsequent step. The fluorination is performed at a suitable temperature, e.g. up to 200° C., with aqueous HF, e.g. also with HF as a gas. Under certain circumstances, active fluorination is not required if the oxidic layer is fluorinated during lamp operation by reaction with WF6 and thereby passivated.

### Possible Embodiments

(1) The bulb inner coating includes MgF₂. The thickness of the coating is e.g. in the range of about 50 nm to about 500 nm. The application of coatings of glass walls with MgF₂ is prior art per se. Such coatings can be implemented, for example, by means of sol gel methods, such as WO/2005/097695 for example, and the literature cited therein. Other methods, such as vapor deposition of the bulb walls with MgF₂, are also options for this purpose.

(2) The use of AlF₃ is also possible. AlF₃ can also be applied, for example, using the indirect route of Al₂O₃. The application of Al₂O₃ is described in DE-A 27 01 051. By reaction with fluorine, an AlF₃ layer is formed on the Al₂O₃ surface.

In the case of high-voltage or medium-voltage 120V/230V/240V burners, the burners are e.g. constructed as lamps using rack technology.

Various embodiments are e.g. applicable to the following types of lamps:

Halogen incandescent lamps for general lighting and for photooptical applications, e.g. for a system voltage of from about 200 V to about 260 V.

The technology according to the invention makes it possible e.g. to produce and market more efficient high-voltage halogen lamps.

The sealtightness and completeness of the coating is essential here.

A first aim of various embodiments may be to protect the quartz surface from attack by fluorine-containing, highly reactive substances. A second aim, however, may be to protect the cyclic process from a loss of fluorine as a result of said fluorine being reacted off with the glass to give relatively inert SiF₄. Complete coverage of the inner wall of the bulb by the protective layer without any cracks or pores is therefore important. In addition, substances for the coating which can withstand such an attack even at the temperatures occurring during operation of the lamp are proposed.

The necessity of the coating is justified merely by the possible use of fluorine in a cyclic process. Admixing other halogens is inconsequential for the layer and/or the reactions of the bulb wall do not take place in the case of other halogens. Therefore, the fill may also contain one or more other halides, such as I or Br or Cl, in addition to F.

It is not absolutely necessary for the protective layer to be applied to rack parts such as lead-ins etc. However, this may prove to be advantageous. In any case, this is at least not considered disadvantageous.

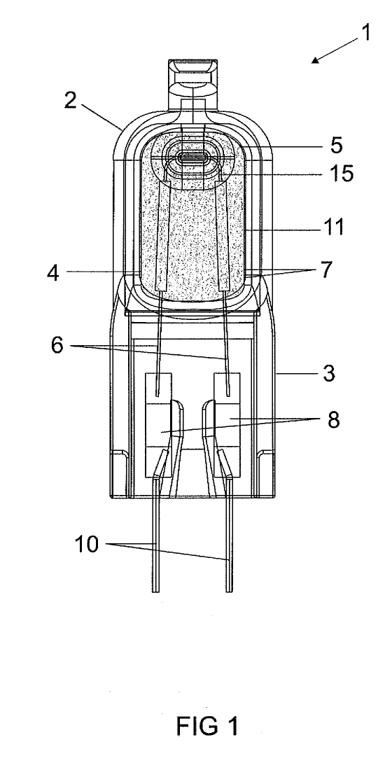

An exemplary embodiment of an HV halogen incandescent lamp 1 is shown in FIG. 1. Said lamp has a burner or bulb 2, which is sealed at one end. This seal is provided by means of a pinch seal 3. A light-emitting element 4 consisting of tungsten which is configured in the form of a U with two light-emitting sections 7 rests in the interior of the burner. Said light-emitting element is held, without the use of a rack, by means of a knob 5, which fixes a connecting piece 15 between the two light-emitting sections 7. The sections 7 end in the inner lead-ins 6, which lead to foils 8 in the pinch seal 3. Outer lead-ins 10 pass to the outside from the foils. The fill of the bulb is a halogen-containing fill, with the halide compound being WF6.

The inner wall of the bulb 2 is coated completely with MgF₂ (11), as a result of which a protective layer protecting against the fluorine is provided.

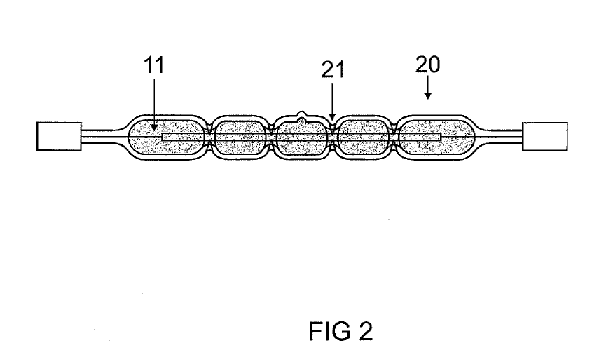

FIG. 2 shows a double-ended lamp 20, which has a plurality of knobs 21 for holding the light-emitting element. In this case, too, WF6 is used as the halogen additive. The inner wall of the bulb is coated completely with MgF₂ (11).

The passive layer which contains fluorine needs to be as transparent as possible, but at least translucent, as the result of the complete coverage.

Under certain circumstances, it may be advantageous to use a diffusing layer.

Possibly, the layer can be configured such that it is non-transparent locally, in which case a particularly passive material can be used at this point which does not have the property of transparency, or this property is only slightly pronounced.

Various embodiments are given as an enumerated list:

In various embodiments, a halogen incandescent lamp with a bulb is provided, in which a light-emitting element and a fill with a halogen-containing additive is accommodated, the halogen containing F, wherein a fluorine-resistant layer which is passive at suitable temperatures is accommodated in the interior of the bulb and completely covers the inner wall.

In various implementations, the layer may include MgF₂, BaF₂, AlF₃, LaF₃, YF₃, CeF₃, TbF₃ alone or as a mixture.

In various implementations, the layer may have a thickness of from about 50 nm to about 500 nm.

In various implementations, the passive layer may include rare earth fluoride glasses of the type SEF3.

In various implementations, the passive layer may include ZrF₄ and fluorine zirconates.

In various implementations, the passive layer may include Na₃AlF₆, Na₅Al₃F₁₄, Ca₅(PO₄)₃F; Al₂F₂SiO₄ and/or fluoroalkyl silanes such as —Si—(CₓH_{(2x+1)-y}F_{y})_{z} and fluorinated polyimides.

In various implementations, the layer maybe transparent.

In various implementations, the layer may be translucent or locally transparent or diffusing.

In various implementations, the halogen incandescent lamp may be operated directly on the system voltage, e.g. on from 80 to 250 V.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A halogen incandescent lamp, comprising:
a bulb, in which a light-emitting element and a fill with a halogen-containing additive is accommodated, the halogen containing F,
wherein a fluorine-resistant layer which is passive at suitable temperatures is accommodated in the interior of the bulb and completely covers the inner wall.

2. The halogen incandescent lamp as claimed in claim 1,
wherein the layer comprises MgF₂, BaF₂, AlF₃, LaF₃, YF₃, CeF₃, TbF₃ alone or as a mixture.

3. The halogen incandescent lamp as claimed in claim 1,
wherein the layer has a thickness of from 50 to 500 nm.

4. The halogen incandescent lamp as claimed in claim 1,
wherein the passive layer comprises rare earth fluoride glasses of the type SEF3.

5. The halogen incandescent lamp as claimed in claim 1,
wherein the passive layer comprises ZrF₄ and fluorine zirconates.

6. The halogen incandescent lamp as claimed in claim 1,
wherein the passive layer comprises at least one of Na₃AlF₆, Na₅Al₃F₁₄, Ca₅(PO₄)₃F; Al₂F₂SiO₄ and fluoroalkyl silanes.

7. The halogen incandescent lamp as claimed in claim 6,
wherein the fluoroalkyl silanes comprise —Si—(CₓH_{(2x+1)-y}F_{y})_{z} or fluorinated polyimides.

8. The halogen incandescent lamp as claimed in claim 1,
wherein the layer is transparent.

9. The halogen incandescent lamp as claimed in claim 1,
wherein the layer is translucent or locally transparent or diffusing.

10. The halogen incandescent lamp as claimed in claim 1,
wherein it is operated directly on the system voltage.

11. The halogen incandescent lamp as claimed in claim 10,
wherein it is operated directly on from 80 to 250 V.
